(19) United States
(12) Patent Application Publication
(10) Pub. No.: US 2025/0059650 A1
(43) Pub. Date: Feb. 20, 2025

(54) SYSTEMS AND METHODS FOR OPERATING ELECTROLYZERS

(71) Applicant: Mitsubishi Power Americas, Inc., Lake Mary, FL (US)

(72) Inventor: Tim Gardner, Worchester, MA (US)

(21) Appl. No.: 18/234,828

(22) Filed: Aug. 16, 2023

(51) Int. Cl. C25B 1/02; C25B 15/027

(52) U.S. Cl. CPC C25B 1/02; C25B 15/027

(57) ABSTRACT

A hydrogen production system comprises a hydrogen production facility comprising electrolyzer units, a controller in communication with the hydrogen production facility, and memory having instructions stored therein executable by the controller to operate the hydrogen production facility, the instructions comprising receiving an instruction signal indicating an available power level, determining availability states of electrolyzer units in the hydrogen production facility to determine a number of available electrolyzer units, determining an available load at which each of the available electrolyzer units is capable of operating relative to a base load, determining a base group of available electrolyzer units having available loads available to consume less than the available power level, determining a trim group of available electrolyzer units to consume any remaining power of the available power level not consumed by the base group of available electrolyzer units, and operating electrolyzer units to produce hydrogen.

### TECHNICAL FIELD

The present application pertains generally, but not by way of limitation, to distributed grid networks that provide electricity from power producers to end users. More specifically, but not by way of limitation, the present application relates to systems that can produce hydrogen with electrical power from a distributed grid network (“the grid”).

### BACKGROUND

Power plants typically supply power to the grid within a distributed network where voltage is provided at a constant amplitude or magnitude and frequency is maintained at a certain value within limits. As such, electrical power can be provided to end users in a consistent format. Electric power grid authorities work to balance power supply with demand. When the demand on the grid changes sufficiently, it can be desirable to bring additional power producers online or have power producers go offline or into a standby mode in order to more closely match production with demand. However, certain power plants, such as nuclear plants, can be configured to operate efficiently at steady state and may have limited flexibility to respond to changes in power demand. Changes in power demand relative to supply can, therefore, be managed by power producing assets with greater flexibility. In some markets, changes in power demand, combined with the forecast for increasing power available from renewable sources, such as solar and wind, may result in reducing, or curtailing, power by power producing assets otherwise having available capacity. That is, otherwise “free” power from renewable sources might not be created or produced because it would result in an imbalance of supply and demand due to, for example, some power plants not being able to effectively or efficiently reduce output.

An alternative to matching power production with power demand is to match power consumption with power production. For example, excess power from renewable energy sources can be used for another purpose, such as to create hydrogen which may be stored, rather than having to curtail renewable power production. Stationery energy storage systems can be used to store excess power generated by the producers. Examples, of typical stationary energy storage systems comprise battery energy storage systems (BESS) that directly store electrical power. Other types of stationary energy storage systems indirectly store the electrical power by converting the excess electrical power to another form that can be used to generate power at a later time, including pumped storage for hydropower. Electrolyzer systems can be used to convert electrical power to hydrogen, which may represent a form of potential energy, e.g., a fuel, that can be stored for use at a later time, such as when electrical power from other sources is low. Electrolyzer systems can split water into hydrogen and oxygen. The hydrogen may be stored, such as in a tank or salt cavern. Hydrogen is particularly advantageous as a storage medium because it can be utilized to create electricity, such as in a fuel cell, or can be used as a fuel in thermal power generation, such as a gas turbine engine, or it may be utilized as a base for derivative materials, such as ammonia. In any use of hydrogen, the resulting power is “green” if the electricity utilized to create hydrogen originated from renewable sources, such as wind or solar.

### Overview

The present inventor has recognized, among other things, that problems to be solved in converting electrical power to forms of stored or potential energy involve various inefficiencies in the conversion process. For example, electrolyzers, over the long term, require maintenance. Various configurations of electrolyzers can have membranes and electrodes that can become damaged or degraded over time and that may result in repair or eventual replacement. Further, electrolyzers provide optimum efficiency and durability when operating at a full power rating, or base load. Electrolyzers provide maximum output when operating at an elevated operating temperature. That is, the output of an electrolyzer increases as operating temperature approaches optimal operating temperature. Cycling electrolyzer load, such as when renewable electricity supply changes, can result in reduced operational efficiency of a hydrogen production facility. Further, within a hydrogen production facility containing multiple electrolyzers, allocation of available renewable electricity load among the electrolyzers can impact the maintenance schedule for the electrolyzers. This problem may be acute in very large hydrogen production facilities that incorporate more than forty to hundreds of electrolyzers in one facility, for example. Each electrolyzer can use over ten megawatts (“MW”) of power in some hydrogen production facilities. The precise, even distribution of such large amounts of energy under dynamic load conditions is a unique and challenging problem to be solved, as there are many ever changing variables, such as grid supply, gird demand, multiple power plants operating at different and changing output levels, changing weather conditions, and the like.

The present subject matter can provide solutions to these problems and other problems, such as by providing methods and systems for operating electrolyzers that minimize performance issues related to inefficiencies and maintenance challenges. An electrolyzer system of the present disclosure can include a controller that can automatically select which electrolyzers within a plant of many electrolyzers to utilize to ensure that as many electrolyzers as practical are operating at their full power rating or base load, and also balance selection of the electrolyzers to keep the accumulated use time of electrolyzers within a desired variation band. The load can initially be allocated to as many electrolyzers as practical to operate at full load to consume excess grid power, with the remainder allocated to operating one or more “trim” electrolyzers that can follow load change cycles to provide for exact, accurate control of a specific Megawatt (MW) demand setpoint as determined by the grid operator. Selection of electrolyzers from the group can be those that are already online, that have the least accumulated operating time and that are already at operating temperature.

In an example, a hydrogen production system can comprise a hydrogen production facility comprising a plurality of electrolyzer units, a controller in communication with the hydrogen production facility and memory having instructions stored therein executable by the controller to operate the hydrogen production facility, the instructions comprising receiving an instruction signal indicating an available power level, determining availability states of electrolyzer units in the hydrogen production facility to determine a number of available electrolyzer units, determining an available load at which each of the available electrolyzer units is capable of operating relative to a base load, determining a base group of available electrolyzer units having available loads available to consume less than the available power level, determining a trim group of available electrolyzer units to consume any remaining power of the available power level not consumed by the base group of available electrolyzer units, and operating electrolyzer units of the base group of available electrolyzer units and the trim group of available electrolyzer units to produce hydrogen.

In another example, a method of activating electrolyzer units of a hydrogen production facility in response to available grid capacity can comprise receiving an instruction signal indicating an available power level, determining availability states of electrolyzer units in the hydrogen production facility to determine a number of available electrolyzer units, determining an available load at which each of the available electrolyzer units is capable of operating relative to a base load, determining a base group of available electrolyzer units having available loads available to consume less than the available power level, determining a trim group of available electrolyzer units to consume any remaining power of the available power level not consumed by the base group of available electrolyzer units, and consuming the available power level with the base group of available electrolyzer units and the trim group of available electrolyzer units.

In an additional example, a method for activating electrolyzers in response to available grid capacity can comprise receiving an instruction from a grid controller indicating an available power level, determining available electrolyzer units, determining an accumulated operating time for each of the available electrolyzer units, activating a number of the available electrolyzer units with the least amount of operating time to operate at full output without exceeding the available power level and activating a trim electrolyzer unit of the available electrolyzer units to consume any remaining power of the available power level not consumed by the number of the available electrolyzer units.

In a further example, a hydrogen production system can comprise a plurality of electrolyzer units, a plurality of switches connecting the plurality of electrolyzer units to a power grid, respectively and a controller configured to activate each of the plurality of electrolyzer units based on accumulated operating time to meet excess capacity of the power grid, wherein electrolyzer units having the least amount of accumulated operating time are activated first.

In another example, a hydrogen production system can comprise a hydrogen production facility comprising a plurality of electrolyzer units, a controller in communication with the hydrogen production facility and memory having instructions stored therein executable by the controller to operate the hydrogen production facility, the instructions comprising receiving an instruction signal indicating an available power level, determining a base group of electrolyzer units to consume a first portion of the available power level less than the available power level, determining a trim group of electrolyzer units to consume a second portion of the available power level not consumed by the base group of electrolyzer units, operating the base group of electrolyzer units to produce a steady state output to consume the first portion and operating the trim group of electrolyzer units to produce a variable output to consume the second portion as the available power level fluctuates.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a schematic diagram of a power system illustrating multiple power plants configured to provide electrical power to a hydrogen generation system and end users via a distributed electrical grid network (DEGN) or “grid.”

FIG. 2 is a schematic diagram illustrating an electrolyzer system comprising many trains of electrolyzer units, each train comprised of electrolyzer stacks and gas separators.

FIG. 3 is a schematic diagram illustrating a control system for the system of many electrolyzer units of FIG. 2.

FIG. 4 is a schematic diagram illustrating a controller for the control system of FIG. 3.

FIG. 5 is a graphical representation illustrating an operator interface, e.g., a control panel) of the controller of FIG. 4 indicating various statuses of electrolyzer units in an electrolyzer train.

FIG. 6 is a line diagram illustrating sequential procedures for bringing electrolyzer units of an electrolyzer system online according to the present disclosure.

FIG. 7 is a line diagram illustrating a particular algorithm for determining a sequence for bringing electrolyzer units online according to the present disclosure.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

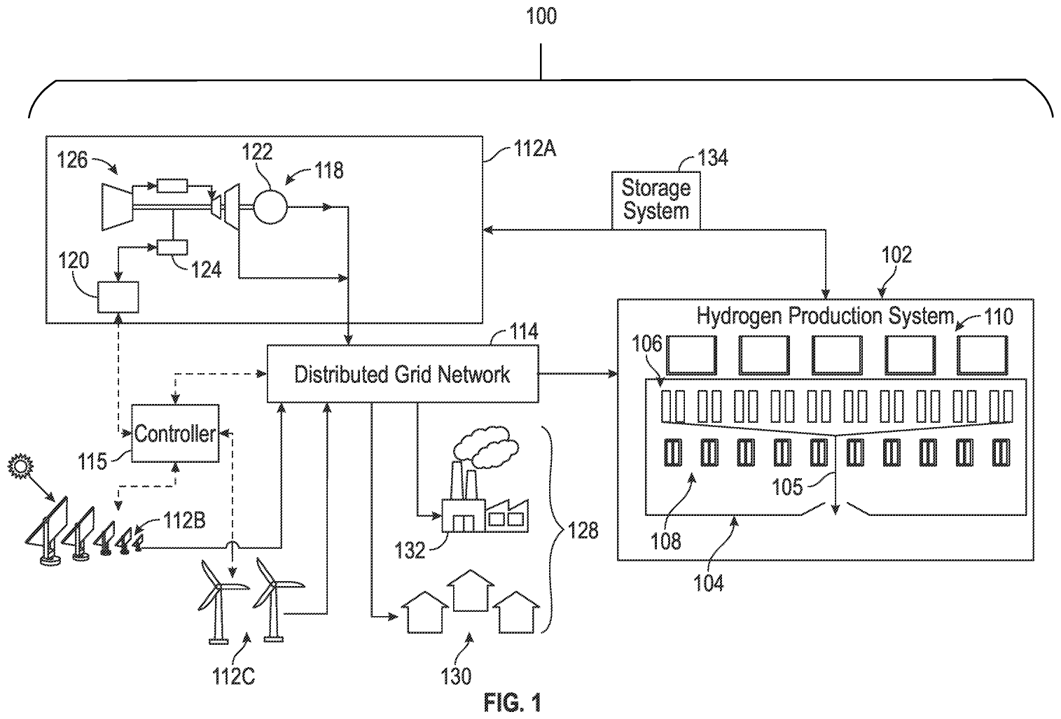

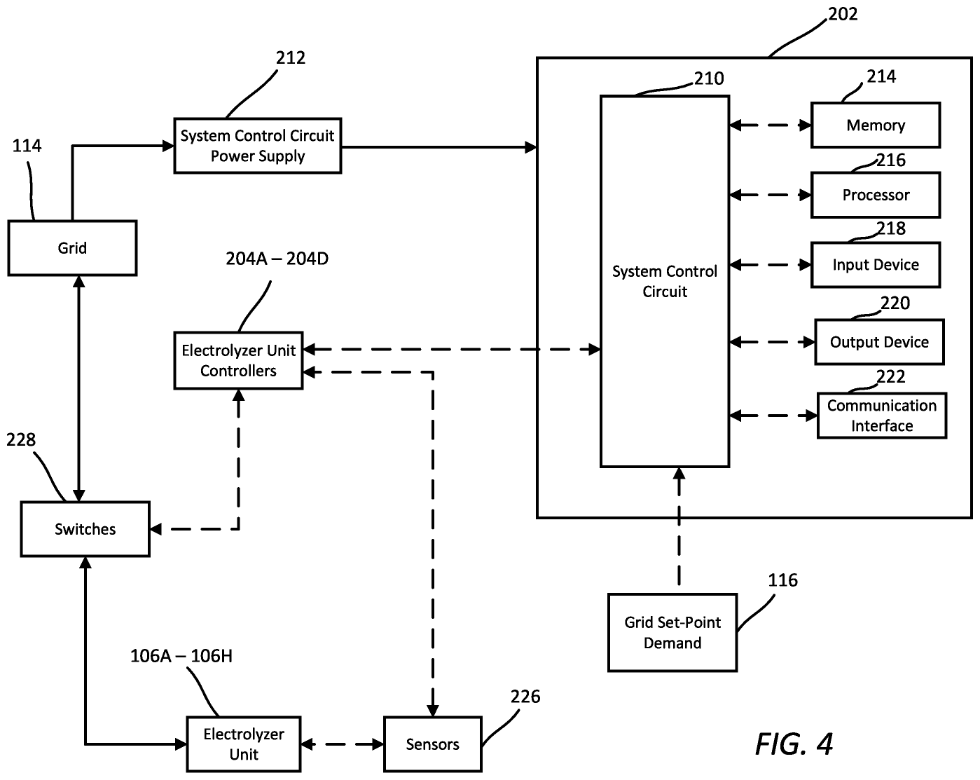

FIG. 1 illustrates a schematic diagram of an example of power system 100 including hydrogen production system 102. Hydrogen production system 102, e.g., hydrogen production facility, can include building 104, electrolyzer units 106, gas separation units 108 and electrical support hardware 110. Power system 100 can also include power plant 112A, power plant 112B and power plant 112C. Power plant 112A can utilize hydrogen gas produced by hydrogen production system 102 to generate electrical power and provide the electrical power to a distributed electrical grid network (DEGN) (e.g., a “grid”), such as grid 114. Grid 114 can comprise grid controller 115 that can issue set-point demand 116 for sending production and consumption instructions to power plants 112A, 112B and 112C, hydrogen production system 102 and end users 128. Grid set-point demand 116 can comprise a communication to facility controller 202 (FIG. 4), such as an electronic communication, a computer signal, a phone call, a fax, a written communication with instructions for consuming power. Power plant 112A can include generator unit 118 and plant controller 120. Generator unit 118 can comprise electrical generator 122, engine controller 124, such as a Distributed Control Systems (DCS) device, and gas turbine engine 126. In examples, gas turbine engine 126 can be a hydrogen-enabled gas turbine engine. In examples, power plant 112A can be configured to receive hydrogen gas from gas separation units 108 of hydrogen production system 102, with or without the use of storage system 134. Grid 114 can be configured to deliver power from power plants 112A, 112B and 112C, to end users 128, which can include residential housing units 130 and one or more of factory 132, and hydrogen production system 102.

Power plants 112A, 112B and 112C can include the same or different types of power plants, such as a thermal combustion power plant, a renewable energy power plant, a nuclear power plant and others. In some examples, power plant 112A can be a gas turbine power plant and power plant 112B and power plant 112C can comprise renewable energy resources, such as wind and solar. Power plant 112A is illustrated as a simple-cycle power plant but can additionally comprise a combined-cycle power plant operating in conjunction with a heat recovery steam generator (HRSG). In examples, power plants 112B and power plant 112C can comprise solar and wind power plants, respectively. Additionally, although power plants 112A, 112B and 112C are shown, the scope of the disclosure is not so limited and power system 100 may include other power plants not depicted here, such as a nuclear power plant or a hydroelectric power plant. Grid controller 115, using grid set-point demand 116, can cooperate with each of power plants 112A-112C to balance electrical power supply with electrical power demand. Additionally, power generated by power plants 112A-112C can be stored for later use. For example, power generated by power plants 112B and 112C in excess of demand therefor can be stored when environmental conditions are favorable for wind and solar energy production for later use when environmental conditions are unfavorable for wind and solar energy production. In a particular example, power plants 112B and 112C can convert renewable energy into electricity for powering hydrogen production system 102 when renewable energy is available, which can then be stored in the form of hydrogen gas for later use with power plant 112A during times of high demand or during times of low availability from power plants 112B and 112C. In view of the above, hydrogen production system 102 can be part of power system 100, such as to at least help provide electricity to end users 128. It will be appreciated that hydrogen produced by hydrogen production system 102 may be utilized for other purposes, such as within industrial processes such as steel making, or may form the feed stock for derivative materials, such as ammonia, for example.

Hydrogen production system 102 can be configured to convert electrical power into a potential energy (e.g., potential electrical energy), such as hydrogen gas. Hydrogen production system 102 can comprise a plurality of individual units that can be linked together in trains to consume large amounts of power from grid 114. These individual units can be located and operated together in a common facility. Building 104 can comprise any suitable building or structure for the housing of electrolyzer units 106, and gas separation units 108 and can include ground surface 105, which can comprise an indoor floor surface, such as cement, asphalt, concrete, pavement, or the like. Electrical support hardware 110 can be located outside of building 104. Building 104 can be vented to the atmosphere to enhance worker safety and compliance with various relevant codes. In examples, hydrogen production system 102 is distinct from end users 128 in that typical end users 128 utilize as much power as they want or request to use a certain amount of power. However, hydrogen production system 102 can be configured to operate in response to whatever power is made available to it. However, hydrogen production system 102 can also operate as an end user.

Electrolyzer units 106 can include various types of electrolyzers, such as, but not limited to, Proton or Polymer Electrolyte Membrane electrolyzers, Solid Oxide electrolyzers and Alkaline electrolyzers. Electrolyzer units 106 can all be the same type of electrolyzer units or can be a mix of different types of electrolyzer units. Electrolyzer units 106 can convert an input of water to into hydrogen gas and oxygen gas using electricity. In examples, gas separation units 108 can be configured to separate the hydrogen gas and the oxygen gas generated by electrolyzer units 106 from an electrolyte such as an alkaline electrolyte. Gas separation units 108 can be in fluid communication with electrolyzer units 106 to enable gas separation units 108 to receive the oxygen gas and hydrogen gas generated by electrolyzer units 106. Electrolyzer units 106 and gas separation units 108 can be arranged within building 104 to form two parallel opposing rows, such as shown in FIG. 1. FIG. 1 illustrates a single train of electrolyzers and gas separators, with twenty of each arranged in pairs. However, hydrogen production system 102 can utilize multiple trains or other configurations of electrolyzer unites 106 and gas separation units 108.

Electrical support hardware 110 can be configured to provide electrical power to various components of hydrogen production system 102, such as to electrolyzer units 106. Electrical support hardware 110 can be connected to grid 114 via various switches and the like. For example, electrical support hardware 110 can include transformers and rectifiers. The transformers can be receptive of a standard voltage alternating current, and can convert the voltage from the standard voltage to a preferred operating voltage. In examples, the standard voltage can be about, but not limited to, 34.5 kilovolts. The transformers can be in electric communication with the rectifiers. The rectifiers can convert alternating current at an operating voltage to direct current for electrolyzer units 106.

Grid controller 115 can cooperate with each of the power plants 112A, 112B and 112C to balance power supply and power demand. It will be appreciated that gas turbine power plants, such as power plant 112A are typically configured to operate most efficiently at or near maximum output. As such, there can be inefficiencies in starting, stopping and changing operation of power plant 112A. Likewise, nuclear power plants also typically only operate at one output level with little variation. Furthermore, weather conditions do not produce steady or constant conditions for producing electricity with wind and solar. Grid controller 115 can set grid set-point demand 116 to match power production to demand, such as by ramping up power from power plant 112A or bringing another power plant online, or can utilize over-production of power to store power or potential energy for later usage, such as by using hydrogen production system 102.

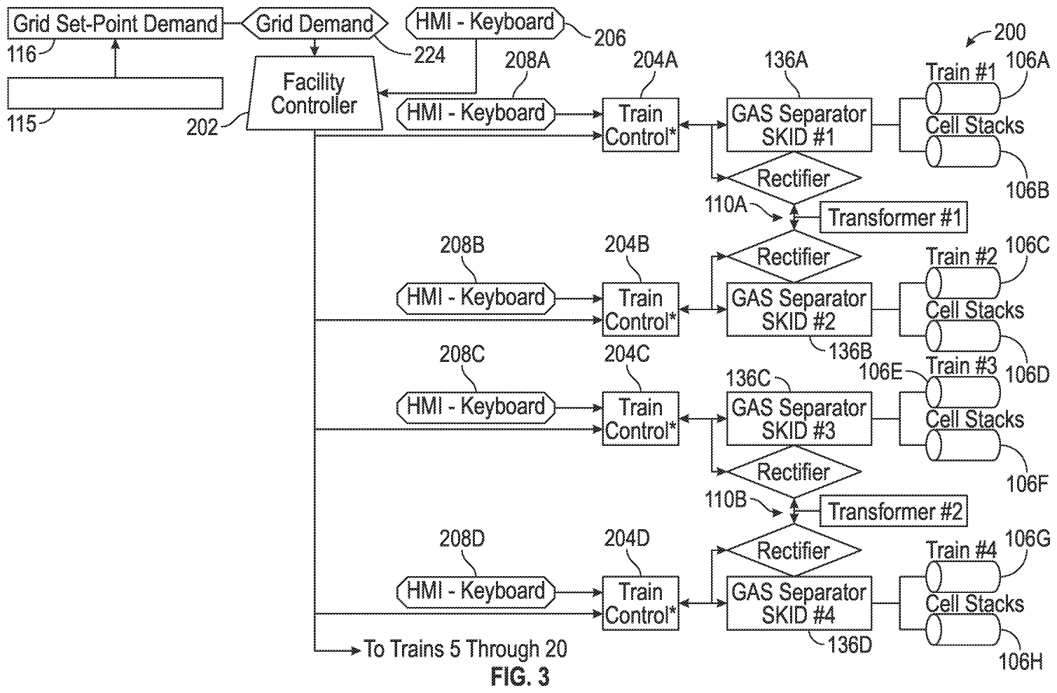

In examples, grid controller 115 can be connected to hydrogen production system 102 to facilitate production of hydrogen for storage in storage system 134. In examples, grid controller 115 can communicate grid set-point demand 116 to facility controller 202 of FIG. 3, which can provide operation instructions to electrolyzer units 106. Grid set-point demand 116 can be configured to provide hydrogen production system 102 with an indication or instruction of how much power is available for hydrogen production. As such, grid controller 115 via grid set-point demand 116 can be configured to issue instructions for hydrogen production system 102 to consume, e.g., capture, energy produced by power plant 112A, power plant 112B and power plant 112C that is not needed by grid 114 in order to reduce the need for operating gas turbine engine 126 or a nuclear power plant at inefficient operating states, for example. Facility controller 202 can, in turn, issue instructions to train controllers 204A-204D, which can issue instructions to individual electrolyzer units 106, or pairs of units, to match consumption of power from grid 114 by electrolyzer units 106. As discussed herein, facility controller 202 can be configured to select electrolyzer units 106 for operation to improve the efficiency of hydrogen production system 102, such as by selecting electrolyzer units 106 having the least amount of accumulated run time to fulfil the request of grid set-point demand 116 to balance the production and consumption of electricity.

In general, due to differing demand levels from end users 128, differing weather conditions for power plant 112B and power plant 112C and other renewable energy sources, as well as other conditions, the amount of electricity available from grid 114 can vary. In times of high demand, it can be useful to have all of power plants 112A, 112B and 112C producing power. In times of low demand, it can be useful to have less than all of power plants 112A, 112B and 112C producing. However, it is not always easy or efficient for grid controller 115 to be able to have the output of power plants 112A, 112B and 112C match the demand from end users 128. Hydrogen production system 102 can be used to match power demand and power production, such as by increasing or decreasing its power consumption via changing its production of hydrogen.

Hydrogen production system 102 can be configured to receive power from grid 114 to match power consumption to power production by converting available power to a stored energy source, such as hydrogen. When power output of power plants 112A-112C exceeds demand from end users 128, such as when a large commercial or industrial consumer goes offline, it can be advantageous to store the excess energy generated by power plants 112A-112C at hydrogen production system 102. For example, it can be more efficient to continue to produce energy and store the excess energy than to shut down or ramp down production, particularly at gas turbine combined cycle (GTCC) power production facilities or nuclear power production facilities. Furthermore, GTCC power production facilities may incur emissions penalties when transitioning operating loads, such as by ramping up or ramping down operation of gas turbine engines. Additionally, power plants that take advantage of renewable energy sources, such as wind and solar, can generate excess power when environmental conditions are favorable for wind and solar energy production. In particular, when power plant 112A is already operating and weather conditions become favorable for operating power plant 112B and 112C, it can be desirable to bring power plants 112B and 112C online, even if demand from end users 128 is low, because power from power plants 112B and 112C is free or almost free and does not result in any environmental emissions. Thus, hydrogen production system 102 can operate to take advantage of this free and clean energy.

Hydrogen production system 102 can be configured to stop consuming power from grid 114 to match power consumption to power production by freeing power for other consumers. When power output of power plants 112A-112C cannot meet the demands of end users 128 and hydrogen production system 102, it can be advantageous to stop or reduce production of hydrogen and oxygen with electrolyzer units 106. For example, hydrogen production system 102 can go offline, or reduce its power consumption, to free up power when a large commercial or industrial consumer comes online or when weather conditions prevent adequate power from being produced by power plants 112B and 112C using renewable energy resources.

Furthermore, energy stored by hydrogen production system 102 at storage system 134 can be released to power plant 112A for the production of power to release to grid 114. Energy from storage system 134 can be consumed when it is desirable or advantageous for grid 114 or other reasons. For example, energy from storage system 134 can be consumed when demand on grid 114 is high, when it is desirable to replace fossil fuels or carbon-producing fuels with green hydrogen, or when supply of fossil fuels to thermal energy producers, e.g., gas turbine engine power plants, is interrupted. It will be appreciated that while storage system 134 is described as storing hydrogen to be utilized by power plant 112A, the scope of the disclosure is not so limited, and that as used herein, storage system 134 may be utilized in various other manners, such as to store hydrogen prior to transportation for use elsewhere, such uses to include as a fuel or as a feed stock to industrial processes or production of other materials, such as ammonia, for example.

In view of the foregoing, hydrogen production system 102 can, therefore, smooth out changes in demand for electricity relative to power producers.

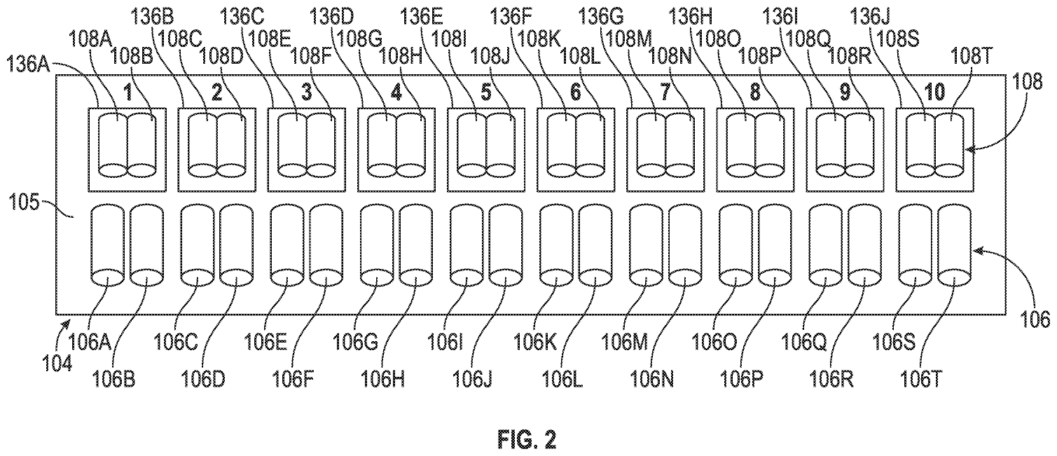

FIG. 2 is a schematic diagram illustrating hydrogen production system 102 of FIG. 1. Hydrogen production system 102 can comprise electrolyzer units 106A-106T and gas separation units 108A-108T. Gas separation units 108A-108T can be arranged in pairs on gas separator skids 136A-136J and electrolyzer units 106A-106T can operate in pairs with each of gas separator skids 136A-136J. Each pair of electrolyzer units and their associated gas separation units can be assigned a number or identifier for facility controller 202 (FIG. 3). In the illustrated example, electrolyzer units 106A and 106B and associated gas separation units 108A and 108B are assigned number 1, electrolyzer units 106C and 106D and associated gas separation units 108C and 108D are assigned number 2, and so on and so forth.

In the illustrated example, hydrogen production system 102 has twenty electrolyzer units. However, hydrogen production system 102 can be configured to have fewer electrolyzer units or additional electrolyzer units, such as forty electrolyzer units.

Electrolyzer units 106A-106T can operate together as a train. However, not all of electrolyzer units 106A-106T need to be operating at the same time, though generally the pairings of electrolyzer units 106A-106T, e.g., electrolyzer units 106A and 106B, generally operate contemporaneously. Gas separation units 108A-108T are configured to operate when their associated electrolyzer unit pairing is operating. As such, at any given point in time, hydrogen production system 102 can exist with electrolyzer units 106A-106T in different states of usage, degradation, temperature, readiness and the like.

FIG. 3 is a schematic diagram illustrating control system 200 for the train of electrolyzer units 106 of FIG. 2. Control system 200 can comprise facility controller 202 and train controllers 204A-204D. FIG. 3 only shows train controllers 204A-204D for electrolyzer units 106A-106H and associated gas separator skids 136A-136D. However, electrolyzer units 1061-106T and gas separator skids 1361-136T (FIG. 2) can be provided with similar electrolyzer controllers. FIG. 4 is a schematic diagram illustrating facility controller 202 for control system 200 of FIG. 3. FIGS. 3 and 4 are discussed concurrently. In an example of FIG. 4, dashed lines can comprise electronic communication signals and solid lines can comprise electrical power lines.

Train controllers 204A-204D can be connected to gas separator skids 136A-136D. Gas separator skids 136A-136D can be in communication with electrical support hardware 110A and 110B, which can comprise rectifiers and transformers as needed to allow electricity from grid 114 to be put into condition for use with electrolyzer units 106A-106H. Facility controller 202 can be connected to interface device 206 and train controllers 204A-204D can be connected to interface devices 208A-208D. Interface device 206 and interface devices 208A-208D can comprise human-machine interface devices, including input and output devices, such as touchscreens, keyboards, mice and the like.

Facility controller 202 can be in communication with grid set-point demand 116, which can provide grid demand signal 224 to facility controller 202. Facility controller 202 can also be in communication with train controllers 204A-204D, which communicate with electrolyzer units 106A-106H for hydrogen production system 102. In examples, train controllers 204A-204D can be part of or incorporated into facility controller 202. Electrolyzer units 106A-106H can be connected to sensors 226 (FIG. 4) and can be connected to system control circuit power supply 212, e.g., grid 114, via switches 228.

Grid controller 115 can be referred to as the “home office” or grid authority for power system 100. Grid 114 can comprise hydrogen production system 102, power plants 112A-112C, high voltage transmission lines that carry power from distant sources to demand centers, and distribution lines that connect end users 128 and hydrogen production system 102. Grid 114 can be configured to operate at a control frequency where all power input into the grid system from disparate sources is input at the same frequency to facilitate integration of the power. In an example, grid 114 can operate at a control frequency of 60 Hertz (Hz).

Grid controller 115 can determine the demand being placed on grid 114, such as by monitoring the consumption of end users 128. Grid controller 115 can coordinate generation of power from power plants 112A-112C and consumption by hydrogen production system 102. Grid set-point demand 116, as issued from grid controller 115 in various formats, can assign or instruct power plant 112A how much power output to contribute to grid 114, and such assignment can be dynamic and reactive based upon the capabilities and availability of any of power plants 112A-112C. Grid controller 115 can ensure that the total power generated by power plants 112A-112C meets the power demand of end users 128. If power demand of end users 128 exceeds or is less than power supplied by power plants 112A-112C, grid controller 115 can dictate response strategies for power plants 112A-112C and hydrogen production system 102. Thus, grid set-point demand 116 can interface with facility controller 202, which can interface with train controllers 204A-204D. Grid set-point demand 116 can come from grid controller 115 or can be provided directly from a power plant, such as a solar or wind power plant, a gas turbine power plant or a nuclear power plant.

It will be appreciated that while embodiments of hydrogen production system 102 have been described as connected to a distributed grid network 114 comprising various producers and consumers of electricity, the scope of the disclosure is not so limited, and may include other hydrogen production facilities connection arrangements. For example, hydrogen production system 102 may be directly connected to source of electricity, such as a dedicated solar farm, a dedicated wind farm, a gas turbine power plant, nuclear power plant or another source of electricity. In such embodiments the hydrogen production system can be responsive to the fluctuating power output of the directly connected source of electricity utilizing the equipment and processes disclosed herein. In some embodiments, the hydrogen production system may be physically co-located with the source of electricity.

Facility controller 202 and train controllers 204A-204D can include various computer system components that facilitate receiving and issuing electronic instructions, storing instructions, data and information, communicating with other devices, display devices, input devices, output devices and the like. Facility controller 202 can include circuit 210, system control circuit power supply 212, memory 214, processor 216, input device 218, output device 220 and communication interface 222. Train controllers 204A-204D can include similar components, but are omitted from FIG. 4 for brevity.

With reference to FIG. 4, circuit 210 can comprise any suitable computer architecture such as microprocessors, chips and the like that allow memory 214, processor 216, input device 218, output device 220 and communication interface 222 to operate together. System control circuit power supply 212 can comprise any suitable method for providing electrical power to facility controller 202, such as AC or DC power supplies. In examples, power from grid 114 can be provided to facility controller 202. Memory 214 can comprise one or more of any suitable memory devices, such as random access memory, read only memory, flash memory, magnetic memory and optical memory. Input device 218 can comprise one or more of a keyboard, mouse, pointer, touchscreen and other suitable devices for providing a user input or other input to circuit 210 or memory 214. Output device 220 can comprise one or more of a display monitor, a viewing screen, a touch screen, a printer, a projector, an audio speaker and the like. Input device 218 and output device 220 can comprise interface device 206 (FIG. 3). Communication interface 222 can comprise devices for allowing circuit 210 to receive information from and transmit information to other computing devices, such as a modem, a router, an I/O interface, a bus, a local area network, a wide area network, the internet and the like.

Circuit 210 can communicate with, that is, read from and write to, a memory device such as memory 214. Memory 214 can include various computer readable instructions for implementing operation of hydrogen production system 102. Thus, memory 214 can include instructions for monitoring demand on and power being supplied to grid 114, such as by receiving grid demand signal 224. Circuit 210 can be connected to various sensors to perform such functions. Memory 214 can also include information that can assist facility controller 202 in providing instruction to train controllers 204A-204D. For example, memory 214 can include the type, size (capacity), age, maintenance history, operating time, location of each of electrolyzer units 106A-106H.

Train controllers 204A-204D can be configured to operate electrolyzer units 106A-106D. Train controllers 204A-204D can include various computer related components, such as circuit boards, memory, processors, input devices, output devices and communications interfaces. Train controllers 204A-204D can be in communication with gas separator skids 136A-136D, electrical support hardware 110A and 110B, and electrolyzer units 106A-106H.

Memory of train controllers 204A-204D can include various computer readable instructions for operating electrolyzer units 106A-106D. The memory can include instructions for monitoring a power generation assignment from facility controller 202, instructions for hydrogen production for each of electrolyzer units 106A-106D, and the like. The memory can include operational and maintenance information, such as the number of operating hours for electrolyzer units 106A-106D. The memory can also include the production efficiency of each of electrolyzer units 106A-106D, such as to reflect any performance degradation of each unit. The memory can include maintenance history for each of electrolyzer units 106A-106D, such as time since last service, repair, overhaul, refurbishment status, the next scheduled maintenance, etc.

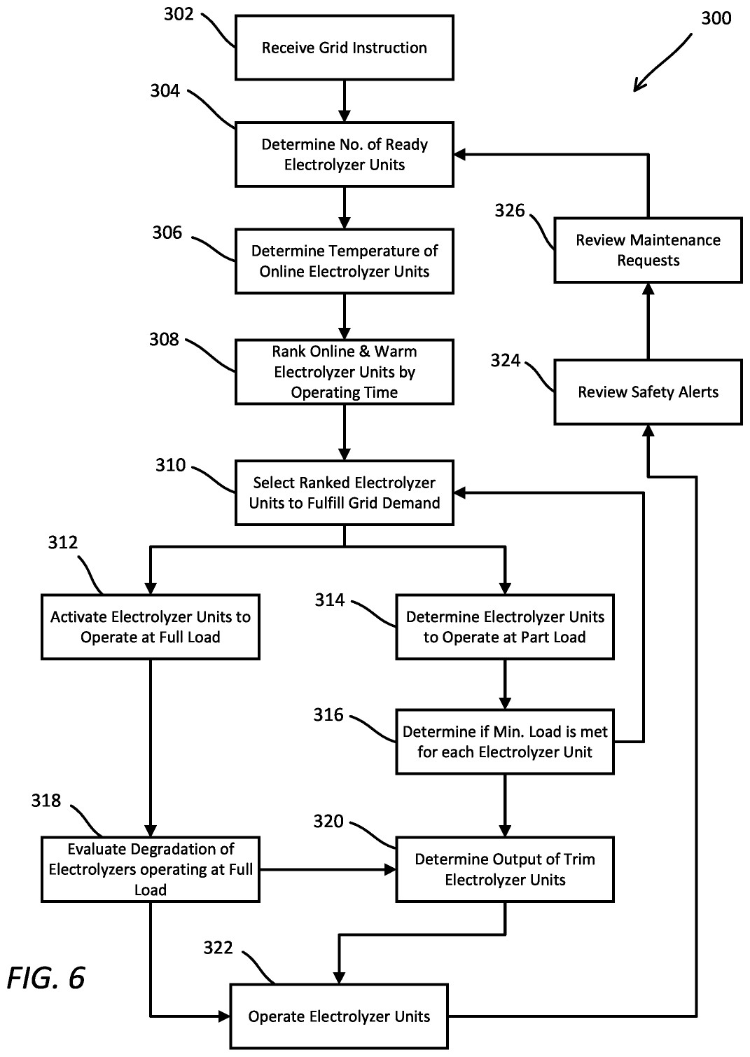

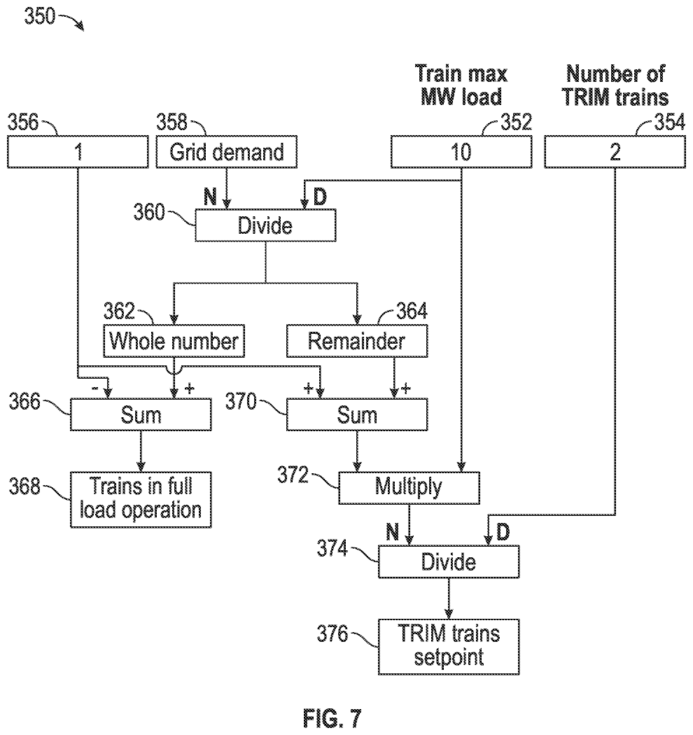

Facility controller 202 can work in conjunction with train controllers 204A-204D to operate electrolyzer units 106A-106H in an efficient and cost-effective manner to maximize or most efficiently operate hydrogen production system 102, such as by controlling operation of electrolyzer units 106A-106H to produce hydrogen when grid demand signal 224 comprises an instruction to consume or utilize a level of power. Thus, memory 214 and the memory of train controllers 204A-204D can include instructions for operating or performing any of the methods described herein, such as those described with reference to FIG. 6 and FIG. 7.

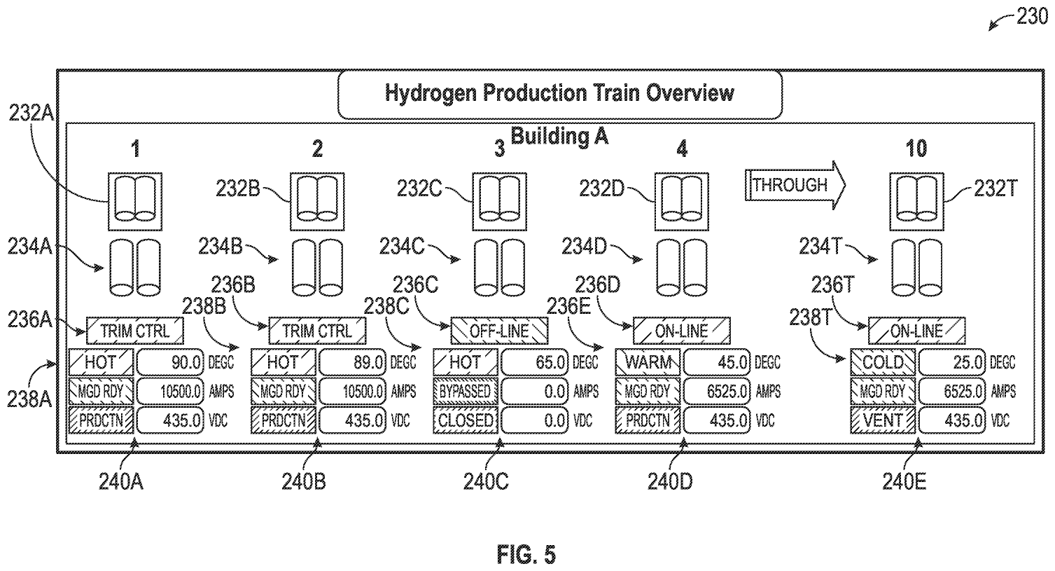

FIG. 5 is a schematic diagram illustrating control panel 230 of facility controller 202 of FIG. 4 indicating various statuses of electrolyzer units in an electrolyzer train. Control panel 230 can comprise input device 218 and output device 220 of FIG. 4. Control panel 230 can comprise a touchscreen display. Control panel 230 can be configured to display electrolyzer icons 232A-232D and 232T, gas separator icons 234A-234D and 234T, status indicators 236A-236D and 236T, temperature indicators 238A-238D and 238T, and output indicators 240A-240D and 240T. FIG. 5 does not show all of electrolyzer icons 232A-232T, gas separator icons 234A-234T, status indicator 236A-236T, temperature indicators 238A-238T, and output indicators 240A-240T for simplicity, but electrolyzer icons, gas separator icons, status indicators, temperature indicators and output indicators for each of electrolyzer units 106A-106T and gas separation units 108A-108T can be provided on control panel 230.

Electrolyzer icons 232A-232T can comprise representations of electrolyzer units 106A-106G. Gas separator icons 234A-234G can comprise representations of gas separator skids 136A-136G. Electrolyzer icons 232A-232T and gas separator icons 234A-234T can be shown next to their number or identifier, e.g., numbers one through ten.

Status indicator 236A-236T can provide indications of the operational statuses of electrolyzer units 106A-106T. As discussed, electrolyzer units 106A-106T can be configured to operate in pairs such that electrolyzer units 106A and 106B are operational or not operational together. Thus, status indicators 236A-236T can provide “online” and “offline” status indicators.

Temperature indicators 238A-238T can provide indications of the temperatures of electrolyzer units 106A-106T. Temperature indicators 238A-238T can provide indications of “cold,” “warm” and “hot.” The cold temperature indicator can indicate that the electrolyzer units are not ready to produce hydrogen, such as by either being offline or by having just recently come online. The warm temperature indicator can indicate that the electrolyzer units are online and ready to produce hydrogen, but not yet at full capacity. The hot temperature indicator can indicate that the electrolyzer units are online and ready to produce hydrogen at full capacity or base load. In examples, cold electrolyzer units can have a temperature of approximately twenty degrees Celsius or below, warm electrolyzer units can have a temperature in the range of approximately twenty-one degrees Celsius to approximately fifty degrees Celsius, and hot electrolyzer units can have a temperature in the range of approximately fifty-one degrees Celsius to approximately ninety degrees Celsius. In examples, the low end of the warm temperature range can comprise a threshold temperature at which it is determined to use the electrolyzer unit or wait until the electrolyzer unit has warmed up more before using. As discussed herein, an excessively high temperature of an electrolyzer unit can indicate a fault condition.

Output indicators 240A-240T can provide indications of the output of electrolyzer units 106A-106J. Output indicators 240A-240T can provide indications of current and voltage usage of electrolyzer units 106A-106T. Output indicators 240A-240T can indicate zero amps and volts for offline electrolyzer units. Output indicators 240A-240T can indicate the full amp and volts for online and hot electrolyzer units. Output indicators 240A-240T can indicate an intermediate amount of amps and the full volts for online and warm electrolyzer units.

### Example Operations of Hydrogen Production Systems

Generally, the amount of power that grid 114 desires to provide to hydrogen production system 102 is, to some extent, scheduled, with periodic updates, in the form of a demand number that can comprise grid demand signal 224 (FIG. 3). Here, the term “demand” is used to indicate the amount of excess power that grid 114 desires to provide to hydrogen production system 102 to maintain grid balance. If, for example, each of electrolyzer units 106 operates at a base load of ten megawatts (MW) and the grid demand is thirty-four megawatts, facility controller 202 will allocate thirty megawatts to three “base” electrolyzer units 106, and four megawatts to one of electrolyzer units 106 to act as a “trim” electrolyzer. As the grid demand fluctuates, between thirty and forty megawatts, the load allocated to the trim electrolyzer will also fluctuate, in order to allow the three base electrolyzers to operate at their base load of ten MW each for a total of thirty megawatts of base load.

In some plants, electrolyzer units 106 can operate in pairs (or groups of other multipliers), which may be known as a “train” in order to accommodate advantageous plant layout and operational arrangements. Consider for example, if electrolyzer units 106 are operated in pairs of two electrolyzers per train. In such an example, twenty megawatts would be allocated to a base train and fourteen megawatts would be allocated to the trim train, which would follow the load variation.

Additionally, at the time that electrolyzer units 106 will be selected to start up, facility controller 202 can select, in ascending order, to operate electrolyzer units 106 that have the least accumulated operational hours, in order to balance the operational hours among all of electrolyzer units 106 within hydrogen production system 102.

However, there are also minimum loads at which electrolyzer units 106 should operate. If the grid demand is such that the trim train would operate beneath the minimum load, then the load allocated among electrolyzer units 106 acting as the base electrolyzers will be reduced in order to be able to operate the trim electrolyzer above the minimum load.

Electrolyzer units 106 at different operational states, such as lye temperature, current density, pressure, and being online/offline, will respond to load differently. That is, depending upon the operational state, electrolyzer units 106 can initiate production at different rates. For example, a cold electrolyzer unit 106 will take longer to produce at full capacity than a warm electrolyzer unit 106. Facility controller 202 can evaluate the operational states of electrolyzer units 106 in allocating load to electrolyzer units 106. For example, continuing the above example of a thirty-four megawatt demand, if electrolyzer units 106 are cold, six electrolyzer units 106, each allocated five megawatts, may initially be required, with a seventh of electrolyzer units 106 acting as a trim electrolyzer to which four megawatts of load can be allocated, to accept the grid demand of thirty-four megawatts. As electrolyzer units 106 come up to proper operating temperature, facility controller 202 can ramp up the per-electrolyzer unit load and, as appropriate, reduce the number of base load electrolyzer units from six to three, each allocated ten megawatts. As such, facility controller 202 can prioritize electrolyzer operational state over ascending cumulative run time to sequence in the electrolyzer units 106 to meet the grid demand.

Additionally, there may be occasions where, for some reason, the amount of hydrogen that one of electrolyzer units 106 that is operating at base load may gradually decrease. This may be known as degradation, and can be due to factors such as reduced electrical efficiency between catalyst/electrode and electrolyte/lye. Facility controller 202 can be configured to sense that such an electrolyzer is unable to produce hydrogen at best efficiencies, and facility controller 202 can respond by increasing the allocation to the trim electrolyzer, so that, in sum, hydrogen production system 102 can continue to accept the full thirty-four megawatt load. In other words, the trim electrolyzer can accommodate operational fluctuations, such that to an outside observer, e.g., grid set-point demand 116, there is no discernable operational fluctuation, and expected hydrogen production and/or efficiency thereof is maintained.

Facility controller 202 can be integrated with safety systems to further ensure no discernable operational fluctuation of demand is provided to grid 114. If any safety matter results in the shutdown of operating electrolyzer units 106, facility controller 202 can re-assign and allocate load among other electrolyzer units 106 not affected by the safety matter. For example, while facility controller 202 is continuously monitoring and controlling the operations of electrolyzer units 106 and gas separation units 108, as well as responding to control room operator actions, the integrated safety system can respond to unsafe operating conditions to immediately shut down the unsafe electrolyzer unit 106 in an orderly, sequenced and safe fashion. This instantaneously stops hydrogen production for that electrolyzer unit 106, and may also under certain conditions initiate a safety purge of gaseous nitrogen. Examples of safety issues that facility controller 202 can be equipped to monitor can include 1) elevated hydrogen gas levels, 2) low H2 gas purity, 3) leaking H2 gas, 4) temperature, 5) liquid lye temperature, 6) loss of control power, and 7) instrument air pressure.

Electrolyzer units 106 can be activated in ascending sequence, starting those with the least accumulated hours, and as electrolyzer units 106 are de-activated, they can be de-activated in descending sequence, starting with electrolyzer units 106 that have the greatest accumulated hours. As described above, the prioritization of accumulated runtime, including sub-categories for trim and base operation, for the selection can be balanced with a need to prioritize based upon operational state, e.g., temperature.

Facility controller 202 can also allow a control room operator to manually select both the start and stop sequence order, as well as to “lock out” or bypass any of electrolyzer units 106 for maintenance or other reasons. In both the automatic sequence mode wherein the sequence order selected by accumulated run time is coordinated by facility controller 202, or manual control room operator sequence order selection, this lockout/bypass feature capability can be active. It can be desirable to perform maintenance upon electrolyzer units 106 in a particular order relative to the plant layout, e.g., where the electrolyzer units 106 are located in building 104 relative to obstructions such as walls, other electrolyzer units and other equipment. If a particular arrangement of equipment, such as electrolyzer units 106, gas separator skids 136A-136J, electrical support hardware 110, is desired to be maintained in a particular order, facility controller 202 can modify the activation and deactivation of electrolyzer units 106 to ensure that the accumulated operational hours for electrolyzer units 106 matches the particular order.

FIG. 6 is a line diagram illustrating method 300 including operations and procedures for bringing electrolyzer units 106 of hydrogen production system 102 into an operational state according to the present disclosure. FIG. 6 is discussed with reference to operation 302-operation 326, but can be implemented with additional or fewer operations. In examples, some of operation 302-operation 326 can be omitted and operation 302-operation 326 can be performed in other sequences.

At operation 302, a hydrogen production system can receive a grid instruction. For example, facility controller 202 of hydrogen production system 102 can receive grid demand signal 224. Grid demand signal 224 can include an instruction to consume or utilize a level of power from grid 114. Grid demand signal 224 can come from a grid controller or can comprise an integrating element between a dedicated solar or wind farm, or another source of electricity including a turbine, and hydrogen production system 102. Here, the term “demand” is used to indicate the amount of excess power that grid 114 desires to provide to hydrogen production system 102 to maintain grid balance. As such, grid set-point demand 116 can be requesting hydrogen production system 102 to store excess energy from grid 114 in the form of hydrogen gas. Hydrogen gas can be stored in storage system 134, which can comprise pressurized tanks or salt caverns. Such stored hydrogen gas can comprise potential energy for later usage. Grid set-point demand 116 can issue grid demand signal 224 when, for example, it is infeasible for a power plant such as a nuclear power plant or power plant 112A to ramp down production due to decreased demand by end users 128 or increased production from power plant 112B and power plant 112C due to improved weather conditions.

At operation 304, the number of electrolyzer units that are ready for use can be determined. For example, facility controller 202 can determine which of electrolyzer units 106A-106T are connectable to grid 114. A ready electrolyzer unit 106 can be an electrolyzer unit that is ready to be connected to grid 114 through electrical support hardware 110 and switches 228, and ready to be activated or put online to produce hydrogen. In other words, a ready electrolyzer unit 106 is not isolated from grid 114, such as to be receiving maintenance operations. Facility controller 202 can be connected to sensors 226 that can determine if electrolyzer units 106 are powered up or capable to be powered-up and thus ready to operate or powered-down and ready for maintenance.

Facility controller 202 can be connected to switches 228 that can connect and disconnect electrolyzer units 106 from grid 114. Facility controller 202 can automatically control the state of switches 228 and thereby be aware of which of electrolyzer units 106 are connected to grid 114 or not.

At operation 306, the temperature of the ready electrolyzer units can be determined. A temperature sample can be taken from each electrolyzer unit. For example, facility controller 202 can determine which of electrolyzer units 106A-106T that are ready are sufficiently warm to perform gas separation functions. Facility controller 202 can be connected to temperature sensors, such as sensors 226 (FIG. 4) connected to electrolyzer units 106A-106T that can sense various temperatures of electrolyzer units 106A-106T, such as lye temperature, exterior or housing temperature and the like. Thus, even though some of electrolyzer units 106 can be disconnected from grid 114, they can be connected to a power source, such as system control circuit power supply 212, to be preheated. Additionally, electrolyzer units 106A-106T can take a large amount of time to warm up or cool down, such as on the order of hours or days. As such, some of electrolyzer units 106A-106T may be in a warm state from previously being connected to grid 114, such as for executing a previous grid instruction. In examples, some or all of electrolyzer units 106A-106T can be maintained in a warm or operational state by heat provided by an industrial process, electric heaters or heat provided by other power plants, such as water or steam from a boiler, HRSG, or nuclear power plant.

At operation 308, the online and warm electrolyzer units can be ranked or prioritized to fulfill the grid demand received at operation 302. For example, facility controller 202 can utilize the sequence numbers (e.g., numbers 1 through 10 of FIG. 2) to electronically arrange electrolyzer units 106A-106T in a priority sequence based on 1) ready, e.g., maintenance, status, 2) temperature (or other operational) state and 3) total run time or accumulated operation time. Each of electrolyzer units 106A-106T can include a usage timer that runs when the electrolyzer unit is generating gas. The usage timer can keep a running total of accumulated operation time for the associated electrolyzer unit. The accumulated operation time can be stored in memory and transmitted in an electronic format for transmission to and storage in memory of train controllers 204A-204T, which can then be accessed by facility controller 202 or stored in memory 214 of facility controller 202. Once accumulated run time for each of electrolyzer units 106 is determined, facility controller 202 can organize or rank electrolyzer units 106A-106T in order of least accumulated run time having the highest priority (e.g., ready to be used first) to the greatest amount of accumulated run time having the least priority (ready to be used last). Furthermore, facility controller 202 may increase or decrease selection prioritization based upon accumulated run time of an electrolyzer unit within the trim or base mode. That is, it may be desirable to distribute operational time as a trim electrolyzer unit among electrolyzer units 106A-106T, such that no electrolyzer unit is used exclusively as a base unit or trim unit, thereby minimizing any potential drawbacks to operating below base load. Thus, facility controller 202 can be configured to choose different ones of electrolyzer units 106A-106T to serve as trim electrolyzer units at the beginning of operations in response to grid set-point demand 116 or in the middle of a response to grid set-point demand 116. Thus, accumulated total run time can include sub-categories of accumulated total run time as a trim electrolyzer unit and accumulated total run time as a base electrolyzer unit and such sub-categories can be included or excluded, as desired, e.g., such as by operator selection, by facility controller 202 in prioritizing or ranking electrolyzer units 106A-106T for selection or inclusion in the different categories, e.g., trim and base categories as described herein.

The prioritization of electrolyzer units 106A-106T can additionally be organized by temperature, either by superseding the accumulated usage or by being subservient to the accumulated usage. That is, electrolyzer units with the same or similar accumulated usage can be prioritized by temperature, or hot electrolyzer units can be ranked ahead of warm electrolyzer units regardless of accumulated usage. This prioritization can be dynamic, such that as a temperature of an electrolyzer unit 106 changes in time, its prioritization relative to other electrolyzer units may be changed.

The sequence numbers (e.g., numbers 1 through 10 of FIG. 2) can be electronically arranged by facility controller 202 to prioritize usage. Additionally, the order of electrolyzer icons 232A-232T and gas separator icons 234A-234T on control panel 230 can be electronically rearranged to provide a user with a visual indication of the order of electrolyzer units 106A-106T for usage.

At operation 310, the ranked or prioritized electrolyzer units 106 can be selected to fulfill the grid demand. For example, facility controller 202 can select which of electrolyzer units 106A-106T that are ready and not in a maintenance mode, that have the least accumulated runtime, that are hot or warm shall be used (such as by closing switches 228) to meet the power consumption level requested by grid demand signal 224. In examples, operation 310 can utilize the methods and algorithms discussed with reference to FIG. 7. Further discussion of operation 310 is made with reference to operation 312 and operation 314 in accordance to the decision-making process of FIG. 7.

At operation 312, the electrolyzer units for operation at full load are selected as mentioned in operation 310. For example, facility controller 202 can determine the number of electrolyzer units 106 desired or needed to meet grid demand signal 224 without exceeding the requested power consumption value in grid demand signal 224. This number of electrolyzer units 106 can be configured to operate at full output or at their base load. This number of electrolyzer units 106 can be selected from the ranking of electrolyzer units 106 having the least amount of accumulated run time, as determined in operation 310. These electrolyzer units 106 can additionally be prioritized or ordered according to temperature so that those at or near operational temperature will be used first.

At operation 314, the electrolyzer units for operation at part load, such as to operate as a trim electrolyzer, are selected as mentioned at operation 310. For example, facility controller 202 can determine the number of electrolyzer units 106 desired or needed to consume any remaining power of the requested power consumption value in grid demand signal 224 not consumed by the electrolyzer units identified in operation 312. This number of trim electrolyzer units of electrolyzer units 106 can be configured to operate at partial output or reduced from their base load. This number of electrolyzer units 106 can be selected from the ranking of electrolyzer units 106 having the least amount of accumulated run time, as determined in operation 310. These electrolyzer units 106 can additionally be prioritized or ordered according to temperature so that those at or near operational temperature will be used first.

At operation 316, it can be determined if the electrolyzer units determined to be operated at part load are operating at or above a minimum load rating. For example, electrolyzer units 106 can have a rating that is a portion of their base load where it is undesirable to operate the electrolyzer unit due to inefficiency or for potential damage to the electrolyzer unit. In examples, the minimum load rating can be thirty percent, forty percent, or fifty percent of the base load. If facility controller 202 determines that operation 314 determined that one or more trim electrolyzers is to operate below the minimum load rating, facility controller 202 can “borrow” output from one of the electrolyzer units selected at operation 312. That is, facility controller 202 can instruct one or more of the selected base electrolyzer units 106 to operate below the base load rating by a number of megawatts required to bring the trim electrolyzer unit 106 to the minimum load rating. Thus, method 300 can return to operation 310 to reallocate load output to accommodate minimum load rating.

At operation 318, the electrolyzer units can be evaluated for degradation. In examples, facility controller 202 can determine if any of electrolyzer units 106 is operating below where they are configured to operate or consuming less power than they would be if not degraded. Consumption of less power than tasked is correlated to reduced output of hydrogen and oxygen. In examples, facility controller 202 can monitor the power consumption of electrolyzer units, such as by using appropriate current or power sensors, to compare the power consumption to the power that each electrolyzer unit 106 is instructed to consume. If there is a discrepancy where an electrolyzer unit 106 is consuming less power, facility controller 202 can instruct the trim electrolyzer unit 106 to increase consumption of power by a proportional amount to ensure that all the available power from grid 114 is consumed. Operation 318 is described with reference to electrolyzer units 106 selected at operation 312, but can also be applied to electrolyzer units 106 selected at operation 314.

At operation 320, the output of the number of selected part load or trim electrolyzer units can be determined. For example, facility controller 202 can account for power not consumed by the base electrolyzer units (e.g., operations 312 and 314), the minimum load requirements of the electrolyzer units (e.g., operation 316) and degraded performance of the base electrolyzer units (e.g., operation 318) to set a final load or power consumption value for the trim electrolyzer unit or units.

At operation 322, the ranked and selected electrolyzer units can be operated to meet the grid instruction. For example, electrolyzer units 106 selected for operation at operation 312 and operation 314 can be activated to generate gas and can be run continuously to meet grid demand signal 224. Facility controller 202 can close switches 228 for the selected electrolyzer units 106 determined to consume power. However, facility controller 202 can continuously monitor for updates to grid demand signal 224 in order to reevaluate how to best fulfill the grid demand instruction request, after performing other checks for safety and maintenance. That is, electrolyzer units 106 can be activated and deactivated as described herein, e.g., based on total operating time, etc., to consume more or less power as directed by grid set-point demand 116. For example, electrolyzer units 106 with the lower accumulated run time can be activated first and electrolyzer units 106 with the highest accumulated run time can be deactivated first. In other words, electrolyzer units 106 can be activated in ascending order based on total accumulated run time and deactivated in descending order based on total accumulated run time.

At operation 324, safety alerts for the electrolyzer units can be reviewed. For example, facility controller 202 can monitor output of sensors, such as sensors 226 of FIG. 4, connected to electrolyzer units 106A-106T to determine if any of electrolyzer units 106A-106T should be moved off-line. During operation of electrolyzer units 106A sensors 226 can provide output to facility controller 202 to monitor for fault conditions and potentially dangerous situations or indications that an electrolyzer unit 106 is operating improperly. As mentioned, facility controller 202 can be configured to determine elevated temperature levels, elevated gas levels, leaking gas, loss of power, loss of instrument air pressure and the like. Memory 214 of facility controller 202 can be provided with threshold levels for these sensor outputs where operation of an electrolyzer unit 106 should be stopped if met or exceeded. Thus, at operation 324, facility controller 202 can stop one or more of electrolyzer units 106 from operating in order to prevent a safety issue from arising and allow responsive maintenance to occur.

At operation 326, maintenance requests for the electrolyzer units can be reviewed. For example, facility controller 202 can review maintenance schedules for electrolyzer units 106A-106T to determine if any of electrolyzer units 106A-106T should be moved off-line. Memory 214 of facility controller 202 can be provided with maintenance schedules for electrolyzer units 106, which can be based on calendar date, accumulated usage or sensor output, where operation of an electrolyzer unit 106 can be stopped to allow for maintenance routine or preventative maintenance.

After performing operation 324 and operation 326, facility controller 202 can return to operation 302 to review grid demand signal 224 and reevaluate the temperature status of electrolyzer units 106 and the like. Any of electrolyzer units 106 pulled out of use at operation 324 or operation 326 for safety or maintenance can be replaced with another electrolyzer unit 106 ranked at operation 308. Thus, method 300 can be continuously and dynamically operated by facility controller 202 to fulfill the requirements, e.g., power consumption request, of grid set-point demand 116 whether static or updating over time.

FIG. 7 is a line diagram illustrating method 350 for executing a particular algorithm for determining a sequence for bringing electrolyzer units 106 into an operational state according to the present disclosure. Method 350 can include operation 352 through operation 376 that can be performed by facility controller 202, such as by following instructions stored in memory 214. In examples, some of operation 352-operation 376 can be omitted and operation 352-operation 376 can be performed in other sequences.

At operation 352, the maximum megawatt load of electrolyzer units 106 can be entered into facility controller 202 or facility controller 202 can read the maximum megawatt load from memory 214. In the illustrated example, the maximum megawatt load for electrolyzer unit 106 can be ten megawatts. The maximum megawatt load can be for an individual electrolyzer unit 106 or for a pair of electrolyzer units 106. The maximum megawatt load for electrolyzer 106 can comprise the maximum amount of power that can be consumed to produce hydrogen gas or, conversely, the amount of power consumed when electrolyzer unit 106 is producing the maximum amount of hydrogen gas.

At operation 354, the desired number of trim trains can be entered into facility controller 202 or facility controller 202 can read the number of trim trains from memory 214. In the illustrated example, the number of trim trains can be set to two. In other examples, a single trim train can be used, and the number indicated at operation 354 can be increased based on calculations performed by facility controller 202, such as at operation 316 of FIG. 6. Additionally, the number of trim trains can be selected based on the difference between the maximum train load and the minimum train load to ensure that the gap therebetween can be covered by an adequate number of trim electrolyzer units operating at the minimum train load.

At operation 356, a correction factor can be entered into facility controller 202 or facility controller 202 can read a correction factor from memory 214. In the illustrated example, the correction factor can be one. The correction factor can be provided to ensure the calculations of method 350 are executed properly, e.g., do not result in an error, or to ensure that the minimum train load will be met.

At operation 358, facility controller 202 can receive grid demand signal 224 indicating a “demand” of a number of megawatts available for use by hydrogen production system 102. In the illustrated example, the grid demand can be thirty-four megawatts.

At operation 360, the grid demand can be divided by the input at operation 352 to determine a whole number at operation 362 and a remainder at operation 364. In operation 360, the grid demand can be the numerator and the maximum megawatt load can be the denominator. In the illustrated example, the whole number at operation 362 can be three and the remainder at operation 364 can be four.

At operation 366, the whole number from operation 362 can be subtracted from the value at operation 356. In the illustrated example, operation 366 can be two.

At operation 368, the total number of electrolyzer units 106 to be operating at full output is equal to the output at operation 366. In the illustrated example, the total number of electrolyzer units 106 operating at full output can be two to provide a total output of twenty megawatts.

At operation 370, the remainder from operation 364 can be added to the value at operation 356. In the illustrated example, operation 368 can be one and four tenths (1.4).

At operation 372, the output at operation 370 can be multiplied by the input at operation 352. In the illustrated example, the output of operation 372 can be fourteen (e.g., 1.4 multiplied by 10).

At operation 374, the output of operation 372 can be divided by the input at operation 354. The output of operation 372 can be the numerator and the number in operation 354 can be the denominator. In the illustrated example, the output of operation 374 can be 7 (e.g., 14 divided by 2).

At operation 376, the output set point for the trim trains can be set to the output of operation 374. In the illustrated example, the total number of electrolyzer units 106 operating at part load as trim electrolyzers can be two to provide a total output of fourteen megawatts.

In examples, the teachings of the present disclosure can be used to smooth out consumption of power to match grid supply. Hydrogen production system 102 can consume power, such as by starting operation of some or all of electrolyzer units 106, while other energy producers are in transition, e.g., ramping down to go offline, after a large energy-consuming commercial or industrial end user goes offline, or when an abundance of renewable energy is available; or hydrogen production system 102 can help free-up power, such as by stopping operation of some or all of electrolyzer units 106, while other energy producers are in transition, e.g., ramping up operations to come online, after a large energy-consuming commercial or industrial end user comes online, or when there is a deficit of renewable energy available. Hydrogen production system 102 can, therefore, smooth out changes in demand for electricity relative to power producers.

Furthermore, hydrogen production system 102 can be operated to selectively operate electrolyzer units 106 to maximize efficiency and minimize maintenance. For example, electrolyzer units 106 that are not in a maintenance state can be prioritized, electrolyzer units 106 that are fully at operating temperature can be prioritized, and electrolyzer units 106 that have the least amount of total operating time can be prioritized. Facility controller 202 can automatically select the number of electrolyzer units 106 to operate at full load and partial load to meet the instructions from grid demand signal 224. Facility controller 202 can be configured to automatically operate electrolyzer units 106 based on sensor input and grid demand signal 224 to minimize manual selection of electrolyzer units 106 for operation.

In examples of the present disclosure, electrolyzer units 106 of hydrogen production system 102 can be triaged or divided into two categories for responding to grid demand signal 224. The first category can be considered the base category and the second category can be considered the trim category.

Electrolyzer units 106 in the base category can be selected to operate at their base load, which can be their maximum load. Electrolyzer units 106 in the base category can be controlled by facility controller 202 to operate independent of changes in grid demand. Changes or variations in the operation or output of electrolyzer units 106 in the base category will typically only occur due to the individual operating characteristics of each electrolyzer unit 106 due to, for example, temperature and degradation. As such, electrolyzer units 106 in the base category can operate below their base load for a temporary amount of time until they reach their operating temperature. Output of electrolyzer units 106 in the base category will typically not react to fluctuations, particularly small fluctuations, in the grid demand signal.

Electrolyzer units 106 in the trim category can be selected to operate below their base load, which can be below maximum load, but above a minimum load. Electrolyzer units 106 in the trim category can be controlled by facility controller 202 to operate dependent on changes in grid demand as presented by the grid demand signal. Changes or variations in the operation or output of electrolyzer units 106 in the trim category will additionally occur due to the individual characteristics of each electrolyzer unit 106 due to, for example, temperature and degradation. However, electrolyzer units 106 in the trim category can operate below their base load for an extended period of time to match grid demand to grid supply per grid demand signal 224

Electrolyzer units 106 of the base category can be operated as described herein to meet the whole number demand at operation 362. If enough electrolyzer units 106 are already at operating temperature so they will be achieving maximum output, facility controller 202 can select electrolyzer units 106 for the base category based on other criteria than temperature, such as accumulated run time. For example, facility controller 202 will not always select electrolyzer units 106 that are at operating temperature in order to distribute run time amongst all of electrolyzer units 106. Additionally, if the selected electrolyzer units 106 will already be at operating temperature, output of electrolyzer units 106 can be steady. However, since not all of electrolyzer units 106 in the base category will always be at operating temperature, the output of individual electrolyzer units 106 can vary, which can mean that the total number of electrolyzer units 106 can vary, e.g., can be reduced, as operating temperatures and associated output increase.

Electrolyzer units 106 selected for the trim category can be controlled by facility controller 202 to meet the remainder number at operation 364. Facility controller 202 can actively control electrolyzer units 106 in the trim category such that changes in output due to temperature are automatically accounted for as facility controller 202 is instructing the trim electrolyzers to provide a specific output below their maximum output. Thus, as a trim electrolyzer warms up in temperature, facility controller 202 can command the trim electrolyzer to produce a lower percentage of available output to maintain steady output as long as the remainder number at operation 364 remains unchanged.

In a first operating scenario, assume all of electrolyzer units 106 are at operating temperature. In such a scenario, facility controller 202 can execute the operations of method 350 to determine the exact number of electrolyzer units for the base category and the trim category. Facility controller 202 can select active electrolyzer units for the base category based on lowest accumulated run time, for example, to distribute run time amongst all of electrolyzer units in hydrogen production system 202.

In a second operating scenario, assume all of electrolyzer units 106 are at a temperature less than the operating temperature. In such a scenario, facility controller 202 can execute the operations of method 300 to determine a temporary number of electrolyzer units for the base category based on temperature and output to meet grid demand signal 224 while the electrolyzer units continue to increase in temperature. Note that while the electrolyzer units are continuing to warm, the trim category of electrolyzer units can still be assigned electrolyzer units as necessary to accommodate changes in the grid demand signal. After a sufficient number of electrolyzer units 106 have warmed to operating temperature, facility controller 202 can execute the operations of method 350 to determine the exact number of electrolyzers units for the base category and the trim category. As more electrolyzer units become available, e.g., become warmed to the operating state, facility controller 202 can actively or continuously select active electrolyzer units for the base category based on lowest accumulated run time, for example, to distribute run time amongst all of electrolyzer units in hydrogen production system 202. The selected trim electrolyzer units can continue to operate as trim electrolyzers reacting to fluctuation in the grid demand signal.

### EXAMPLES

### First Example Claim Set: Sorting into Base and Trim Groups Based on Availability of Electrolyzers

Example 1 is a hydrogen production system comprising: a hydrogen production facility comprising a plurality of electrolyzer units; a controller in communication with the hydrogen production facility; and memory having instructions stored therein executable by the controller to operate the hydrogen production facility, the instructions comprising: receiving an instruction signal indicating an available power level; determining availability states of electrolyzer units in the hydrogen production facility to determine a number of available electrolyzer units; determining an available load at which each of the available electrolyzer units is capable of operating relative to a base load; determining a base group of available electrolyzer units having available loads available to consume less than the available power level; determining a trim group of available electrolyzer units to consume any remaining power of the available power level not consumed by the base group of available electrolyzer units; and operating electrolyzer units of the base group of available electrolyzer units and the trim group of available electrolyzer units to produce hydrogen.

In Example 2, the subject matter of Example 1 optionally includes wherein the instructions further comprise: controlling the base group of available electrolyzer units based on operational states of the base group of available electrolyzer units; and controlling the trim group of available electrolyzer units based on fluctuations in the available power level.

In Example 3, the subject matter of any one or more of Examples 1-2 optionally include wherein the instructions further comprise: controlling which electrolyzer units are in the base group of available electrolyzer units based on at least one of temperature, maintenance state and accumulated run time; and actively controlling power consumed by electrolyzer units in the trim group of available electrolyzer units as the available power level changes.

In Example 4, the subject matter of Example 3 optionally includes wherein the instructions further comprise: controlling the trim group of available electrolyzer units based on fluctuations in the available power level by actively controlling output of electrolyzer units in the trim group of available electrolyzer units based on operational states of the trim group of available electrolyzer units.

In Example 5, the subject matter of any one or more of Examples 2-4 optionally include wherein determining the availability states of the electrolyzer units in the hydrogen production facility comprises determining if the electrolyzer units are at or above a threshold operating temperature.

In Example 6, the subject matter of Example 5 optionally includes wherein the threshold operating temperature comprises a first operating temperature where an electrolyzer unit can produce a minimum load or a second operating temperature where an electrolyzer unit can produce a maximum load.

In Example 7, the subject matter of any one or more of Examples 5-6 optionally include where the instructions further comprise: determining that at least one of the available electrolyzer units is below the threshold operating temperature such that the available load for the at least one available electrolyzer unit is below base load; and re-determining the available load for the at least one of the available electrolyzers as its operating temperature increases to or above the threshold operating temperature.

In Example 8, the subject matter of Example 7 optionally includes wherein the instructions further comprise reducing a total number of operating electrolyzer units as temperature and corresponding output of the available electrolyzer units increases.

In Example 9, the subject matter of any one or more of Examples 1-8 optionally include wherein determining available electrolyzer units comprises determining which electrolyzer units of a train of installed electrolyzer units are online or offline.

In Example 10, the subject matter of any one or more of Examples 1-9 optionally include wherein determining availability states of the electrolyzer units in the hydrogen production facility to determine the number of available electrolyzer units comprises: determining an accumulated run time for each of the available electrolyzer units; ranking the available electrolyzer units in order of lowest accumulated run time; and allocating the available electrolyzer units to the base group of available electrolyzer units based on lowest accumulated run time.

In Example 11, the subject matter of Example 10 optionally includes wherein the instructions further comprise: determining if the available electrolyzer units assigned to the trim group of available electrolyzer units will be operating below a minimum load to consume the available power level not consumed by the base group of available electrolyzer units; increasing an output level of the trim group of available electrolyzer units to meet the minimum load; and correspondingly decreasing an output level of at least one of the base group of available electrolyzer units.

In Example 12, the subject matter of any one or more of Examples 10-11 optionally include deactivating each of the electrolyzer units based on highest accumulated operating time.

In Example 13, the subject matter of any one or more of Examples 1-12 optionally include wherein determining availability states of the electrolyzer units in the hydrogen production facility to determine the number of available electrolyzer units comprises: determining a degradation state of an individual electrolyzer unit; and adjusting output of the trim group of available electrolyzer units to compensate for degradation of the individual electrolyzer unit.

In Example 14, the subject matter of any one or more of Examples 1-13 optionally include wherein the instructions further comprise: adjusting the base group of available electrolyzer units to allow one or more electrolyzer units of the base group of available electrolyzer units to be taken offline for maintenance.

In Example 15, the subject matter of any one or more of Examples 1-14 optionally include wherein the instruction signal is received from a grid controller.

In Example 16, the subject matter of Example 15 optionally includes wherein the instructions further comprise: determining that one or more power producers are generating power output above demand such that the instruction signal from the grid controller indicates an excess power level; and initiating operation of the hydrogen production facility to consume the excess power level.

In Example 17, the subject matter of Example 16 optionally includes wherein the one or more power producers generating power output above demand comprises at least one of: a nuclear energy plant and a renewable energy power plant.

In Example 18, the subject matter of any one or more of Examples 1-17 optionally include a plurality of switches connecting the plurality of electrolyzer units to a power grid, respectively; wherein the instructions further comprise operating one or more switches of the plurality of switches to connect the base group of available electrolyzer units and the trim group of available electrolyzer units to the power grid.

In Example 19, the subject matter of any one or more of Examples 1-18 optionally include wherein each of the available electrolyzer units is capable of operating at a base load, the instructions further comprising: dividing the available power level by the base load to obtain a quotient and a remainder; determining a base number of electrolyzer units from the available electrolyzer units equal to the quotient to form the base group of available electrolyzer units; determining a trim load from the remainder; activating the base number of electrolyzer units; activating a trim number of available electrolyzer units to consume the trim load; and generating hydrogen with the base number of electrolyzer units and the trim group of available electrolyzer units.

Example 20 is a method of activating electrolyzer units of a hydrogen production facility in response to available grid capacity, the method comprising: receiving an instruction signal indicating an available power level; determining availability states of electrolyzer units in the hydrogen production facility to determine a number of available electrolyzer units; determining an available load at which each of the available electrolyzer units is capable of operating relative to a base load; determining a base group of available electrolyzer units having available loads available to consume less than the available power level; determining a trim group of available electrolyzer units to consume any remaining power of the available power level not consumed by the base group of available electrolyzer units; and consuming the available power level with the base group of available electrolyzer units and the trim group of available electrolyzer units.

In Example 21, the subject matter of Example 20 optionally includes controlling the base group of available electrolyzer units based on operational states of the base group of available electrolyzer units; and controlling the trim group of available electrolyzer units based on fluctuations in the available power level.

In Example 22, the subject matter of any one or more of Examples 20-21 optionally include wherein: controlling which electrolyzer units are in the base group of available electrolyzer units based on at least one of temperature, maintenance state, and accumulated run time; and actively controlling power consumed by electrolyzer units in the trim group of available electrolyzer units as the available power level changes.

In Example 23, the subject matter of Example 22 optionally includes controlling the trim group of available electrolyzer units based on fluctuations in the available power level comprises actively controlling output of electrolyzer units in the trim group of available electrolyzer units based on operational states of the trim group of available electrolyzer units.

In Example 24, the subject matter of any one or more of Examples 20-23 optionally include wherein consuming the available power level with the base group of available electrolyzer units and the trim group of available electrolyzer units comprises operating one or more switches to connect the base group of available electrolyzer units and the trim group of available electrolyzer units to a power distribution grid.

In Example 25, the subject matter of any one or more of Examples 20-24 optionally include wherein determining the availability states of the electrolyzer units in the hydrogen production facility comprises determining if the electrolyzer units are at or above a threshold operating temperature.

In Example 26, the subject matter of Example 25 optionally includes wherein the threshold operating temperature comprises a first operating temperature where an electrolyzer unit can produce a minimum load.

In Example 27, the subject matter of any one or more of Examples 25-26 optionally include wherein the threshold operating temperature comprises a second operating temperature where an electrolyzer unit can produce a maximum load.

In Example 28, the subject matter of any one or more of Examples 25-27 optionally include determining that at least one of the available electrolyzer units is below the threshold operating temperature such that the available load for the at least one available electrolyzer unit is below base load; and re-determining the available load for the at least one of the available electrolyzers as its operating temperature increases to or above the threshold operating temperature.

In Example 29, the subject matter of Example 28 optionally includes reducing a total number of operating electrolyzer units as temperature and corresponding output of the available electrolyzer units increases.

In Example 30, the subject matter of any one or more of Examples 20-29 optionally include wherein determining available electrolyzer units comprises determining which electrolyzer units of a train of installed electrolyzer units are online or offline.

In Example 31, the subject matter of any one or more of Examples 20-30 optionally include wherein determining availability states of the electrolyzer units in the hydrogen production facility to determine the number of available electrolyzer units comprises: determining an accumulated run time for each of the available electrolyzer units; ranking the available electrolyzer units in order of lowest accumulated run time; and allocating the available electrolyzer units to the base group of available electrolyzer units based on lowest accumulated run time.

In Example 32, the subject matter of Example 31 optionally includes determining if the available electrolyzer units assigned to the trim group of available electrolyzer units will be operating below a minimum load to consume the available power level not consumed by the base group of available electrolyzer units; increasing an output level of the trim group of available electrolyzer units to meet the minimum load; and correspondingly decreasing an output level of at least one of the base group of available electrolyzer units.

In Example 33, the subject matter of any one or more of Examples 31-32 optionally include deactivating each of the electrolyzer units based on highest accumulated operating time.

In Example 34, the subject matter of any one or more of Examples 20-33 optionally include wherein determining availability states of the electrolyzer units in the hydrogen production facility to determine the number of available electrolyzer units comprises: determining a degradation state of an individual electrolyzer unit; and adjusting output of the trim group of available electrolyzer units to compensate for degradation of the individual electrolyzer unit.

In Example 35, the subject matter of any one or more of Examples 20-34 optionally include adjusting the base group of available electrolyzer units to allow one or more electrolyzer units of the base group of available electrolyzer units to be taken offline for maintenance.

In Example 36, the subject matter of any one or more of Examples 20-35 optionally include wherein the instruction signal is received from a grid controller.

In Example 37, the subject matter of Example 36 optionally includes determining that one or more power producers are generating power output above demand such that the instruction signal from the grid controller indicates an excess power level; and initiating operation of the hydrogen production facility to consume the excess power level.

In Example 38, the subject matter of Example 37 optionally includes wherein the one or more power producers generating power output above demand comprises at least one of: a nuclear energy plant and a renewable energy power plant.

In Example 39, the subject matter of any one or more of Examples 20-38 optionally include wherein each of the available electrolyzer units is capable of operating at a base load, the method further comprising: dividing the available power level by the base load to obtain a quotient and a remainder; determining a base number of electrolyzer units from the available electrolyzer units equal to the quotient to form the base group of available electrolyzer units; determining a trim load from the remainder; activating the base number of available electrolyzer units; activating a trim number of available electrolyzer units to consume the trim load; and generating hydrogen with the base number of electrolyzer units and the trim group of available electrolyzer units.

Each of these non-limiting examples can stand on its own, or can be combined in various permutations or combinations with one or more of the other examples.

### Second Example Claim Set: Sorting into Base and Trim Groups Based on Accumulated Run Time

Example 1 is a method for activating electrolyzers in response to available grid capacity, the method comprising: receiving an instruction from a grid controller indicating an available power level; determining available electrolyzer units; determining an accumulated operating time for each of the available electrolyzer units; activating a number of the available electrolyzer units with the least amount of operating time to operate at full output without exceeding the available power level; and activating a trim electrolyzer unit of the available electrolyzer units to consume any remaining power of the available power level not consumed by the number of the available electrolyzer units.

In Example 2, the subject matter of Example 1 optionally includes wherein the trim electrolyzer unit is selected from the available electrolyzer units with the least amount of operating time.

In Example 3, the subject matter of any one or more of Examples 1-2 optionally include determining if the trim electrolyzer unit will be operating below a minimum load to consume the remaining power; increasing an output level of the trim electrolyzer unit to meet the minimum load; and decreasing an output level of one of the number of the available electrolyzer units.

In Example 4, the subject matter of any one or more of Examples 1-3 optionally include wherein activating the number of the available electrolyzer units of the available electrolyzer units with the least amount of operating time to operate at full output without exceeding the available power level comprises: activating electrolyzer units having the least amount of accumulated operating time to operate first.

In Example 5, the subject matter of any one or more of Examples 1-4 optionally include wherein determining available electrolyzer units comprises determining which electrolyzer units of a train of installed electrolyzer units is online.

In Example 6, the subject matter of any one or more of Examples 1-5 optionally include wherein determining available electrolyzer units comprises: determining a temperature sample of an individual electrolyzer unit; determining if the temperature sample of the individual electrolyzer unit is above a threshold temperature; activating the individual electrolyzer unit if the temperature sample is above the threshold temperature; and selecting another electrolyzer unit of the number of the available electrolyzer units if the temperature sample is below the threshold temperature.

In Example 7, the subject matter of Example 6 optionally includes reevaluating the temperature sample of the individual electrolyzer unit; and adjusting the number of the available electrolyzer units that is activated to consume the available power level.

In Example 8, the subject matter of Example 7 optionally includes reducing a total number of activated electrolyzer units as temperature and corresponding output of the activated electrolyzer units increases.

In Example 9, the subject matter of any one or more of Examples 1-8 optionally include deactivating each of the electrolyzer units based on decreasing accumulated operating time.

In Example 10, the subject matter of any one or more of Examples 1-9 optionally include determining a degradation state of an individual electrolyzer unit; and adjusting output of the trim electrolyzer unit to compensate for degradation of the individual electrolyzer unit.

In Example 11, the subject matter of any one or more of Examples 1-10 optionally include adjusting the number of the available electrolyzer units to allow one or more of the electrolyzer units to be taken offline for maintenance.

In Example 12, the subject matter of any one or more of Examples 1-11 optionally include determining that one or more power producers are generating power output beyond demand such that the instruction from the grid controller indicates an excess power level; and initiating operation of a hydrogen production system to consume the excess power level.

In Example 13, the subject matter of Example 12 optionally includes wherein the one or more power producers comprises a nuclear energy plant operating at a base level above the demand.

In Example 14, the subject matter of any one or more of Examples 12-13 optionally include wherein the one or more power producers comprises a renewable energy power plant.

Example 15 is a hydrogen production system comprising: a plurality of electrolyzer units; a plurality of switches connecting the plurality of electrolyzer units to a power grid, respectively; and a controller configured to activate each of the plurality of electrolyzer units based on accumulated operating time to meet excess capacity of the power grid, wherein electrolyzer units having the least amount of accumulated operating time are activated first.

In Example 16, the subject matter of Example 15 optionally includes wherein the controller comprises a non-transient computer readable storage medium having stored therein instructions for: receiving an instruction from a grid controller indicating an available power level; determining available electrolyzer units from the plurality of electrolyzer units; determining an accumulated operating time for each the available electrolyzer units; activating a number of the available electrolyzer units with the least amount of accumulated operating time to operate at full output without exceeding the available power level; and activating a trim electrolyzer unit of the available electrolyzer units to consume any remaining power of the available power level not consumed by the number of the available electrolyzer units.

In Example 17, the subject matter of Example 16 optionally includes wherein the trim electrolyzer unit is selected from the available electrolyzer units with the least amount of operating time.

In Example 18, the subject matter of any one or more of Examples 16-17 optionally include a plurality of sensors connected to the plurality of electrolyzer units, respectively, the plurality of sensors comprising one or more of temperature sensors, gas sensors or power sensors, wherein the controller is further configured to automatically adjust the number of the available electrolyzer units that are activated based on increasing output of the number of the available electrolyzers as temperature increases.

In Example 19, the subject matter of any one or more of Examples 16-18 optionally include wherein the controller is further configured to: determining a degradation state of an individual electrolyzer unit; and adjusting output of the trim electrolyzer unit to compensate for degradation of the individual electrolyzer unit.

In Example 20, the subject matter of any one or more of Examples 15-19 optionally include wherein the controller is configured to deactivate each of the plurality of electrolyzer units based on decreasing accumulated operating time.

Each of these non-limiting examples can stand on its own, or can be combined in various permutations or combinations with one or more of the other examples.

### Third Example Claim Set: Sorting into Base and Trim Groups Based on Available Power from Grid

Example 1 is a hydrogen production system comprising: a hydrogen production facility comprising a plurality of electrolyzer units; a controller in communication with the hydrogen production facility; and memory having instructions stored therein executable by the controller to operate the hydrogen production facility, the instructions comprising: receiving an instruction signal indicating an available power level; determining a base group of electrolyzer units to consume a first portion of the available power level less than the available power level; determining a trim group of electrolyzer units to consume a second portion of the available power level not consumed by the base group of electrolyzer units; operating the base group of electrolyzer units to produce a steady state output to consume the first portion; and operating the trim group of electrolyzer units to produce a variable output to consume the second portion as the available power level fluctuates.

In Example 2, the subject matter of Example 1 optionally includes wherein operating the base group of electrolyzer units to produce a steady state output to consume the first portion comprises operating the base group of electrolyzer units based on operational states of the base group of electrolyzer units.

In Example 3, the subject matter of Example 2 optionally includes wherein operating the base group of electrolyzer units based on operational states of the base group of electrolyzer units comprises controlling which electrolyzer units are in the base group of electrolyzer units based on at least one of temperature, maintenance state, accumulated total run time, and accumulated run time in the trim group.

In Example 4, the subject matter of Example 3 optionally includes wherein controlling which electrolyzer units are in the base group of electrolyzer units based on at least one of temperature, maintenance state, accumulated total run time, and accumulate run time in the trim group comprises rotating electrolyzer units through the base group of electrolyzer units to distribute accumulated total run time.

In Example 5, the subject matter of any one or more of Examples 1-4 optionally include wherein operating the trim group of electrolyzer units to produce a variable output to consume the second portion as the available power level fluctuates comprises actively controlling output of electrolyzer units in the trim group of electrolyzer units as the available power level changes.

In Example 6, the subject matter of any one or more of Examples 1-5 optionally include wherein operating the trim group of electrolyzer units to produce a variable output to consume the second portion as the available power level fluctuates comprises controlling output of electrolyzer units in the trim group of electrolyzer units based on operational states of the trim group of electrolyzer units.

In Example 7, the subject matter of Example 6 optionally includes wherein the instructions further comprise: determining availability states of electrolyzer units in the hydrogen production facility to determine a number of available electrolyzer units for the base group of electrolyzer units and the trim group of electrolyzer units.

In Example 8, the subject matter of Example 7 optionally includes wherein determining availability states of the electrolyzer units in the hydrogen production facility to determine the number of available electrolyzer units comprises: determining an accumulated total run time for each of the available electrolyzer units; ranking the available electrolyzer units in order of lowest accumulated total run time; and allocating the available electrolyzer units to the base group of electrolyzer units based on lowest accumulated total run time.

In Example 9, the subject matter of any one or more of Examples 7-8 optionally include wherein determining availability states of the electrolyzer units in the hydrogen production facility to determine the number of available electrolyzer units comprises: determining an accumulated total run time for each of the available electrolyzer units; ranking the available electrolyzer units in order of lowest accumulated total run time; and allocating the available electrolyzer units to the base group of electrolyzer units based on lowest accumulated total run time.

In Example 10, the subject matter of any one or more of Examples 7-9 optionally include determining if the available electrolyzer units assigned to the trim group of electrolyzer units will be operating below a minimum load to consume the available power level not consumed by the base group of electrolyzer units; increasing an output level of the trim group of electrolyzer units to meet the minimum load; and correspondingly decreasing an output level of at least one of the base group of electrolyzer units.

In Example 11, the subject matter of Example 10 optionally includes deactivating each of the electrolyzer units based on decreasing accumulated total run time.

In Example 12, the subject matter of any one or more of Examples 7-11 optionally include wherein determining available electrolyzer units comprises determining which electrolyzer units of a train of installed electrolyzer units are online or offline.

In Example 13, the subject matter of any one or more of Examples 7-12 optionally include wherein determining the availability states of the electrolyzer units in the hydrogen production facility comprises determining if the electrolyzer units are at or above a threshold operating temperature.

In Example 14, the subject matter of Example 13 optionally includes wherein the threshold operating temperature comprises a first operating temperature where an electrolyzer unit can produce a minimum load or a second operating temperature where an electrolyzer unit can produce a maximum load.

In Example 15, the subject matter of Example 14 optionally includes determining that at least one of the available electrolyzer units is below the threshold operating temperature such that an available load for the at least one available electrolyzer unit is below base load; and re-determining the available load for the at least one of the available electrolyzers as its operating temperature increases at or above the threshold operating temperature.

In Example 16, the subject matter of any one or more of Examples 7-15 optionally include wherein determining availability states of the electrolyzer units in the hydrogen production facility to determine the number of available electrolyzer units comprises: determining a degradation state of an individual electrolyzer unit; and adjusting output of the trim group of electrolyzer units to compensate for degradation of the individual electrolyzer unit.

In Example 17, the subject matter of any one or more of Examples 1-16 optionally include wherein the instructions further comprise: adjusting the base group of electrolyzer units to allow one or more electrolyzer units of the base group of electrolyzer units to be taken offline for maintenance.

In Example 18, the subject matter of any one or more of Examples 1-17 optionally include wherein the instruction signal is received from a power plant.

In Example 19, the subject matter of any one or more of Examples 1-18 optionally include wherein the instruction signal is received from a grid controller.

In Example 20, the subject matter of Example 19 optionally includes wherein the instructions further comprise: determining that one or more power producers are generating power output beyond demand such that the instruction signal from the grid controller indicates an excess power level; and initiating operation of the hydrogen production facility to consume the excess power level; wherein the one or more power producers comprises a nuclear energy plant operating at a level above the demand or a renewable energy power plant.

In Example 21, the subject matter of any one or more of Examples 1-20 optionally include a plurality of switches connecting the plurality of electrolyzer units to a power grid, respectively; wherein the controller is further configured to operate one or more switches of the plurality of switches to connect the base group of electrolyzer units and the trim group of electrolyzer units to a power distribution grid.

Each of these non-limiting examples can stand on its own, or can be combined in various permutations or combinations with one or more of the other examples.

### Various Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A hydrogen production system comprising:
a hydrogen production facility comprising a plurality of electrolyzer units;
a controller in communication with the hydrogen production facility; and
memory having instructions stored therein executable by the controller to operate the hydrogen production facility, the instructions comprising:
receiving an instruction signal indicating an available power level;
determining availability states of electrolyzer units in the hydrogen production facility to determine a number of available electrolyzer units;
determining an available load at which each of the available electrolyzer units is capable of operating relative to a base load;
determining a base group of available electrolyzer units having available loads available to consume less than the available power level;
determining a trim group of available electrolyzer units to consume any remaining power of the available power level not consumed by the base group of available electrolyzer units; and
operating electrolyzer units of the base group of available electrolyzer units and the trim group of available electrolyzer units to produce hydrogen.

2. The hydrogen production system of claim 1, wherein the instructions further comprise:
controlling the base group of available electrolyzer units based on operational states of the base group of available electrolyzer units; and
controlling the trim group of available electrolyzer units based on fluctuations in the available power level.

3. The hydrogen production system of claim 1, wherein the instructions further comprise:
controlling which electrolyzer units are in the base group of available electrolyzer units based on at least one of temperature, maintenance state and accumulated run time; and
actively controlling power consumed by electrolyzer units in the trim group of available electrolyzer units as the available power level changes.

4. The hydrogen production system of claim 3, wherein the instructions further comprise:
controlling the trim group of available electrolyzer units based on fluctuations in the available power level by actively controlling output of electrolyzer units in the trim group of available electrolyzer units based on operational states of the trim group of available electrolyzer units.

5. The hydrogen production system of claim 2, wherein determining the availability states of the electrolyzer units in the hydrogen production facility comprises determining if the electrolyzer units are at or above a threshold operating temperature.

6. The hydrogen production system of claim 5, wherein the threshold operating temperature comprises a first operating temperature where an electrolyzer unit can produce a minimum load or a second operating temperature where an electrolyzer unit can produce a maximum load.

7. The hydrogen production system of claim 5, where the instructions further comprise:
determining that at least one of the available electrolyzer units is below the threshold operating temperature such that the available load for the at least one available electrolyzer unit is below base load; and
re-determining the available load for the at least one of the available electrolyzers as its operating temperature increases to or above the threshold operating temperature.

8. The hydrogen production system of claim 7, wherein the instructions further comprise reducing a total number of operating electrolyzer units as temperature and corresponding output of the available electrolyzer units increases.

9. The hydrogen production system of claim 1, wherein determining available electrolyzer units comprises determining which electrolyzer units of a train of installed electrolyzer units are online or offline.

10. The hydrogen production system of claim 1, wherein determining availability states of the electrolyzer units in the hydrogen production facility to determine the number of available electrolyzer units comprises:
determining an accumulated run time for each of the available electrolyzer units;
ranking the available electrolyzer units in order of lowest accumulated run time; and
allocating the available electrolyzer units to the base group of available electrolyzer units based on lowest accumulated run time.

11. The hydrogen production system of claim 10, wherein the instructions further comprise:
determining if the available electrolyzer units assigned to the trim group of available electrolyzer units will be operating below a minimum load to consume the available power level not consumed by the base group of available electrolyzer units;
increasing an output level of the trim group of available electrolyzer units to meet the minimum load; and
correspondingly decreasing an output level of at least one of the base group of available electrolyzer units.

12. The hydrogen production system of claim 10, further comprising deactivating each of the electrolyzer units based on highest accumulated operating time.

13. The hydrogen production system of claim 1, wherein determining availability states of the electrolyzer units in the hydrogen production facility to determine the number of available electrolyzer units comprises:
determining a degradation state of an individual electrolyzer unit; and
adjusting output of the trim group of available electrolyzer units to compensate for degradation of the individual electrolyzer unit.

14. The hydrogen production system of claim 1, wherein the instructions further comprise:
adjusting the base group of available electrolyzer units to allow one or more electrolyzer units of the base group of available electrolyzer units to be taken offline for maintenance.

15. The hydrogen production system of claim 1, wherein the instruction signal is received from a grid controller.

16. The hydrogen production system of claim 15, wherein the instructions further comprise:
determining that one or more power producers are generating power output above demand such that the instruction signal from the grid controller indicates an excess power level; and
initiating operation of the hydrogen production facility to consume the excess power level.

17. The hydrogen production system of claim 16, wherein the one or more power producers generating power output above demand comprises at least one of: a nuclear energy plant and a renewable energy power plant.

18. The hydrogen production system of claim 1, further comprising:
a plurality of switches connecting the plurality of electrolyzer units to a power grid, respectively;
wherein the instructions further comprise operating one or more switches of the plurality of switches to connect the base group of available electrolyzer units and the trim group of available electrolyzer units to the power grid.

19. The hydrogen production system of claim 1, wherein each of the available electrolyzer units is capable of operating at a base load, the instructions further comprising:
dividing the available power level by the base load to obtain a quotient and a remainder;
determining a base number of electrolyzer units from the available electrolyzer units equal to the quotient to form the base group of available electrolyzer units;
determining a trim load from the remainder;
activating the base number of electrolyzer units;
activating a trim number of available electrolyzer units to consume the trim load; and
generating hydrogen with the base number of electrolyzer units and the trim group of available electrolyzer units.

20. A method of activating electrolyzer units of a hydrogen production facility in response to available grid capacity, the method comprising:
receiving an instruction signal indicating an available power level;
determining availability states of electrolyzer units in the hydrogen production facility to determine a number of available electrolyzer units;
determining an available load at which each of the available electrolyzer units is capable of operating relative to a base load;
determining a base group of available electrolyzer units having available loads available to consume less than the available power level;
determining a trim group of available electrolyzer units to consume any remaining power of the available power level not consumed by the base group of available electrolyzer units; and
consuming the available power level with the base group of available electrolyzer units and the trim group of available electrolyzer units.
